(19) United States
(12) Patent Application Publication
(10) Pub. No.: US 2003/0174049 A1
(43) Pub. Date: Sep. 18, 2003

(54) Wearable identification appliance that communicates with a wireless communications network such as bluetooth

(75) Inventors: Michael L. Beigel, Encinitas, CA (US); John Randall Tuttle, Boulder, CO (US); Walter W. Mosher JR., West Hills, CA (US); David E. Wang, Newport Beach, CA (US)

Correspondence Address: LYON & LYON LLP, Suite 4700, 633 West Fifth Street, Los Angeles, CA, 90071, US

(73) Assignee: Precision Dynamics Corporation

(21) Appl. No.: 10/101,471

(22) Filed: Mar. 18, 2002

(51) Int. Cl. G05B 19/00; H04Q 1/00

(52) U.S. Cl. 340/10.42; 340/5.61

(57) ABSTRACT

An identification appliance such as a wristband, headband, armband, ankleband, or legband which has a wireless communication circuit to communicate with a system, network, or device. The identification appliance preferably communicates with a Bluetooth local network and may issue or receive commands or data including voice data. An example command is to expand privileges given to the user of the identification appliance, such as entrance into a restricted area. The information appliance may broadcast its location via a Global Positioning System and have voice activation or speech recognition. The appliance may provide information about the authorized bearer such as his name, address, phone number, passport number, driver's license data, social security number, credit card information, fingerprint data, biometric voice characteristics, retinal characteristics, medical data and so on.

### FIELD OF THE INVENTION

The field of the invention relates generally to wireless communication devices whose functions may be controlled by a local wireless system such as a Bluetooth wireless network and more particularly, to an identification appliance that can communicate wirelessly with a Bluetooth wireless network.

### BACKGROUND OF THE INVENTION

Identification wristbands have become a convenient and effective way of identifying people without permanently marking them. A principle advantage of a wristband is that it is ultimately removable. An identification wristband typically comprise a flexible wrist strap having a length greater than its width, and a closure or securement device for attaching and maintaining the wristband securely around the wearer's wrist. A portion of the wristband may be used for imprinting or otherwise attaching identification or other information regarding the wearer. Bar codes, radio frequency identification (RFID) devices and the like may also be used to store and transfer information associated with the wristband and the associated person or object. Various wristband constructions, attachments and other features including the storage of electronic data and RFID functions are described, for example, in Penuela U.S. Pat. No. 5,493,805, Mosher U.S. Pat. No. 5,457,906, Mosher U.S. Pat. No. 5,973,600, Beigel U.S. Pat. No. 5,973,598, Beigel U.S. Pat. No. 6,181,287, Peterson U.S. Pat. No. 5,479,797 and Peterson U.S. Pat. No. 5,581,924.

Wristbands are advantageous over other forms of ID cards containing data (such as credit cards, tickets or the like) since they can be attached to the wearer physically securely. As a result, current uses of identification wristbands include patient identification in hospitals, clinics and other locations; access in amusement parks; temporary security measures, facility access control, and ticketing and entitlement functions.

One important use for identification wristbands is patient identification and location in hospitals, clinics and other locations. When used in conjunction with an appropriate reader, patient information can be collected electronically and used by the medical staff in performance of their duties. Another example is to track the location of personnel such as convicts in a prison.

Identification wristbands provide information simply, for example by visually reading printed information on the wristband, scanning barcode information, or electronically reading transmitted identification information. Besides identification wristbands, more powerful wireless communication devices are capable of transmitting and/or receiving signals carrying voice or data information. Examples of such wireless communication devices include cellular telephones, pagers, wireless personal assistants, wearable computers with wireless Internet capabilities, and other devices capable of receiving and possibly transmitting information. These other wireless communication devices communicate on and through an existing communication network infrastructure that may be wired or wireless.

Many radio frequency network technologies exist—IEEE 802.11 and Bluetooth, among them. Bluetooth is of particular applicability because of its combination of low power, medium range, voice and small size capabilities. The Bluetooth technology is the result of the joint efforts of nine leading companies within the telecommunication and computer industries—3Com, Ericsson, Intel, IBM, Lucent, Microsoft, Motorola, Nokia and Toshiba—to establish a low-cost, networkable communications standard for cable replacement and Internet connectivity by mobile devices. More than 11000 other manufacturers, from all parts of the world and various fields of business, have now also joined the Bluetooth association.

A Bluetooth local network is a short range wireless communication network as defined by the Bluetooth standard. See the website http://www.bluetooth.com on the internet for additional details about the Bluetooth local network. The Bluetooth local network has a radio transceiver that operates in a globally available frequency band of 2.4 Gigahertz. Currently, the gross data rate is 1 Megabits per second. A Time Division Duplex scheme is used for full-duplex transmission.

The Bluetooth standard defines how compatible devices will communicate with each other. Generally, an integrated circuit incorporates a radio transceiver, the Bluetooth control circuitry and the communications protocol. The Bluetooth technology makes connections quickly and without cable. The Bluetooth protocol provides for the communication of data and voice signals.

The Bluetooth protocol defines a group of eight or fewer networked devices as a Piconet. One of the devices must be designated as a “master” and the others (up to seven) must be “slaves.” A device may belong to more than one Piconet, but may only communicate with one at a time. A Scatternet is a multiplicity of Piconets. An example of a identification tag intended to communicate with a Bluetooth network is PCT Patent titled “An Object Detection System,” international publication no. WO 01/37004 A1, international application no. PCT/DK00/00637, the entirety of which is incorporated herein by reference.

Therefore, there is a need for an identification wristband or appliance which is suitable to be worn and is able to communicate more effectively with a wireless communication network or other devices.

### SUMMARY OF THE INVENTION

The improved identification appliance, such as a wristband, is able to communicate, one-way or two-way, with a wireless communication system, such as a Bluetooth local network.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. Moreover, in the figures, like reference numerals designate corresponding parts throughout the different views. However, like parts do not always have like reference numerals. Moreover, all illustrations are intended to convey concepts, where relative sizes, shapes and other detailed attributes may be illustrated schematically rather than literally or precisely.

FIG. 1 is a high level block diagram representation of an example embodiment of an identification appliance that is adapted to interact with a local wireless communication network.

FIG. 2 is a high level block diagram representation of another example embodiment of an identification appliance that is adapted to interact with a local wireless communication network.

FIG. 3 is a high level block diagram representation of an example embodiment of a single node network that is adapted to interact with an identification appliance.

FIG. 4 is a high level block diagram representation of an example embodiment of a multiple node network that is adapted to interact with an identification appliance.

FIG. 5 is a high level block diagram representation of an example application of a multiple node network in a hospital to create zones to interact with an identification appliance.

FIG. 6 is a high level block diagram representation of an example identification appliance configured as a wristband with a microphone and a headband with an earpiece.

FIG. 7 is a high level block diagram representation of an example identification appliance which permits full duplex communications.

### DETAILED DESCRIPTION OF THE PREFERRED EMBODIMENTS

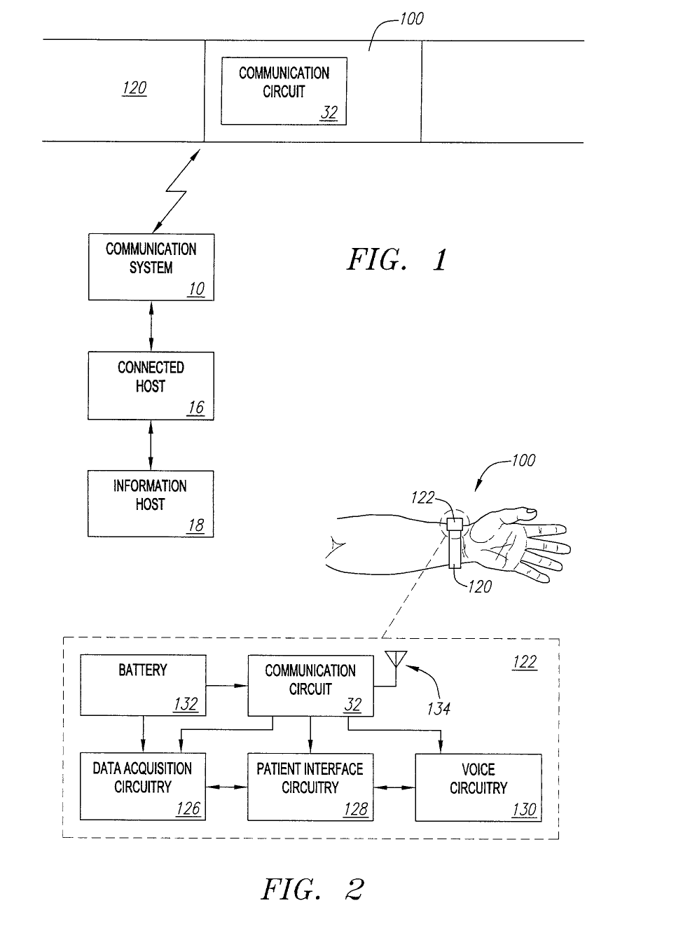

FIGS. 1 and 2 are high level representations of example embodiments of an improved identification appliance 100 that is adapted to interact with a local wireless communication network 10 such as a Bluetooth network. The communication network 10 may be connected to other devices, including a connected host 16 and an information host 18. The identification appliance 100 may take various forms, such as a wristband, bracelet, patch, headband, necklace, belt, card, sticker, or other wearable appliance, which for the sake of convenience, are collectively referred to as a “wristband” or as a “identification appliance”. An example of an identification appliance 100 which is configured as a wristband is illustrated in FIG. 2. The identification appliance 100 has a communication circuit 32, preferably a radio frequency device, which may communicate, one-way or two-way, over a wireless communication network 10 with other devices such as an information host 18. The wireless communication circuit 32 may be adapted to communicate with any kind of remote device, system, or network. If desired, the wireless communication circuit 32 may enable the identification appliance 100 to communicate with more than one type of device, system, and network.

The wireless communication system may be local or wide-area and may include, but is not limited to, a Bluetooth local network, an infrared interface standard (IRDA), a network based on the 802.15 wireless local area network (LAN) standard, a network based on the 802.11 wireless LAN standard, a digital enhanced cordless telephone (DECT), or another communication system. The-improved identification appliance 100 may contain a radio frequency identification (RFID) function of any type or frequency, operate in low and/or high frequencies, be read-only or permit both read and write functions. The improved identification appliance 100 can communicate passively such as a transponder, or actively by initiating communications, or both. Because the improved identification appliance 100 can communicate with the wireless communications network 10 by sending data, receiving data, or both, the identification appliance 100 can perform numerous functions, such as transmit information about the identification and location of the identification appliance's authorized bearer to another device, as explained later.

Preferably, the communication circuit 32 is a Bluetooth communication circuit incorporated into the improved identification appliance 100 which permits the connection of the identification appliance 100 to low-cost, low-power, short range networks. A Bluetooth radio module can be purchased from Cambridge Silicon Radio. A description of various BlueCore™ Single Chip Bluetooth products can be found on the internet at http://www.CambridgeSiliconRadio.com. Additional details about the Bluetooth protocol can be found on the internet at http://www.bluetooth.com. However, Cambridge Silicon Radio's Bluetooth radio module is large in size, which makes it less practical for an identification band such as a wristband. Accordingly, electronic circuits which are either printable (and therefore thin) or made of one or more organic materials, or both may be used to make the Bluetooth communication circuit 32, as will be explained in greater detail later.

Referring to FIG. 1, in order for the improved identification appliance 100 to communicate or interact with the local wireless communication network 10, the improved identification appliance 100 may have a communication circuit 32, such as a Bluetooth integrated circuit chip with a radio transceiver, built into the improved identification appliance 100 as well as any requisite software. The communication circuit 32 is able to communicate with the communication network 10. Because the local wireless communication network 10 is a data network, data as well as commands may be passed between the local wireless communication network 10 and any improved identification appliance 100 located within the operative range of the local wireless communication network 10. The local wireless communication network 10 instantly connects with any improved identification appliance 100 within its range even if the appliance is not within line-of-sight. Additional security and authentication procedures may be used by the local wireless communication network 10 to protect users' privacy and data transmission. The range of a local wireless communication network 10 may or may not overlap the range of other communication networks.

The communication circuit 32 may comprise a control logic, an interface for communicating with the local wireless communication network 10 as well as other communication networks, and a detector for determining whether the communication device 100 is within range of the local wireless communication network 10. The detector may be part of the control logic. The control logic may include any control unit such as a microprocessor, microcontroller, arithmetic logic unit (ALU), central processing unit (CPU), programmable gate array, control circuit, discrete analog or digital hardware and software.

Referring to FIG. 2, the identification appliance 100 comprises a structure 120 which is adapted to be worn by or attached to a person. For example, the structure 120 may be an elongate band to form a wrist band, head band, arm band, or ankle band. A wireless communication circuit 32 may be coupled to other circuits such as a data acquisition circuit 126, an interface circuit 128, and/or a voice circuit 130. These various circuits may be powered by a power source 132, such as a battery. The wireless communication circuit 32 may have an antenna 134 through which signals may be received, transmitted, or both received and transmitted. The data acquisition circuit 126 may include a data storage device, such as any of those described in this disclosure or known to those in the art of data storage. The data storage device may be any kind of memory, such as a write-once or write-many memory, or a combination. For example, the memory may be a random access memory (RAM), read only memory (ROM), programmable read only memory (PROM), electrically erasable PROM (EEPROM), ultraviolet light erasable PROM (UVPROM), fixed disk media, flexible disk media, flash memory, tape, or any other storage retrieval means, or any combination of these volatile and non-volatile memory means. Of course, the movable media devices (e.g., disk and tape) may not be practical for a small wearable identification appliance until the movable media devices become smaller. The data storage device may further permit reading only, reading and writing, or writing only. There should be sufficient memory to store all necessary information in the identification appliance 100. The improved identification appliance 100 can be used with or without reference to a real-time database management program.

The identification appliance 100 may carry optical-electronic components or circuits such as signaling or indicating circuits. The opto-electronic components may perform various functions such as signaling (e.g., by light from a light emitting diode), indicating (e.g., by emitting light or varying reflectances), displaying (e.g., of alphanumeric or image data by pre-formed indicators or matrix of indicators), sensing (e.g., of levels of light or sound), and power conversion (e,g., photovoltaic cell). These components may be of silicon, polymers, or other materials. They may be inflexible and attached on the identification appliance 100. Alternatively, they may be flexible and attached to or printed on the identification appliance 100. The electronic, electro-optical and visual components may be printed or otherwise deposited on the structure 120.

The structure 120 may optionally have a closure mechanism to form a circular band. The closure mechanism may make bands of varying or adjustable sizes. Alternatively, the closure mechanism may make the attachment of the identification appliance 100 to a person secure. The secure identification appliance 100 may be configured to make removal or tampering of the identification appliance 100 difficult or impossible. Still, alternatively, a secure identification appliance 100 may have a tamper-evident function; that is, the secure identification appliance 100 may indicate whether tampering of the appliance 100 was attempted. For example, conductive adhesive attachment of areas of the identification appliance 100 upon fastening to the wearer may activate printed conductive patterns within the identification appliance 100 that inform circuitry that the identification appliance 100 has been attached to a wearer or object. If the adhesive attachment of areas of the identification appliance 100 is broken, the printed conductive patterns would detect the break so that the circuit can detect tampering. The configuration and mode of electrical coupling of conductive patterns in the identification appliance 100 to the circuit may vary according to whether the entire identification appliance 100 is a disposable device, a disposable device attached to a reusable transponder module, or a reusable device. When tampering is detected, the circuit may disable the identification appliance 100 or disable a function or functions of identification appliance 10. Additionally, the circuit may indicate that tampering has occurred by activating a display, alarm, LED and the like, or by informing a person or another device of the tampering. Further, the identification appliance 100 may be physically securely fastened such that tampering or removal of the appliance 100 would destroy its function or render such tampering or removal evident. The securement may be permanent for the usage life of the appliance 10, or may be temporary (e.g., defeatable by an authorized procedure). In the case of temporary securement, the identification appliance 100 may be re-used and re-secured by an authorized agency or person.

When the improved identification appliance 100 enters the operative range of a local wireless communication network 10, the improved identification appliance 100 and the local wireless communication network 10 may communicate with each other. The data storage device contains the information and data for the improved identification appliance 100. For example, the data storage device may contain identification information about the authorized bearer of the improved identification appliance 100, which the identification appliance 100 can transmit to the wireless communication network 10. The identification information can include any kind of information about the authorized bearer such as his name, address, phone number, passport number, driver's license data, social security number, credit card information, fingerprint data, biometric voice characteristics, retinal characteristics and so on. This information may be written or printed visual information. For example, the identification appliance 100 may have a label or a printable surface to contain the information. The written or printed information may include data that is perceivable to humans, animals, or machines. For example, the data may be alphanumeric data, optical character recognizable data (such as bar codes), images, photographs, magnetically readable data, and/or biometric data such as fingerprint, retina, or voice data.

Alternatively or additionally, the data storage device may store a link or address to information stored in an external database. This external database, which may be resident on an external system such as a computer, host system, or wireless network, and can preferably be accessed through the Internet. In such a case, the identification appliance 100 transmits the link or address to the information in the database, whereupon receipt, the receiving device accesses the database and retrieves the actual information. This allows the data storage device to store less information locally, which can make the identification appliance 100 smaller and thinner, while not sacrificing the amount of information being transferred. As an example, the database may store the entire medical history of the authorized bearer of the identification appliance 100, which medical history may be stored on the hospital's computer and which the hospital may update. Thus, by providing a pointer or link to the medical history, the information will be the most recent version and other people may add to, delete from, or otherwise modify the information, if desired. In another example, the database may store the digitized fingerprint data of the authorized bearer of the identification appliance 100, which can require a large amount of storage space that cannot be readily put onto the identification appliance 100.

Preferably, the improved identification appliance 100 operates in the radio frequency region of the electromagnetic spectrum, such as at the frequency of 2.45 GHz used by the Bluetooth protocol. Frequencies other than 2.45 GHz may be used. The selected frequency should be chosen with consideration of the effect of absorption of radio energy by the human body or signal loss over the free space path.

The connection of the improved identification appliance 100 to the wireless communication network 10 facilitates the distribution of information to and from the identification appliance 100. In other words, a wireless communication network 10 may transmit data to or receive data from an improved identification appliance 100 residing within its range. Because information may be stored electronically in the data storage device on the improved identification appliance 100, that information may be communicated to a “reader” or a wireless communication network 10 located in any site such as a hospital, prison, jailhouse, office, amusement park, concert hall and public transportation system such as an airplane, or airport.

Communication between the improved identification appliance 100 and the reader is preferably by the transmission and reception of electromagnetic (EM) waves, where each has an antenna to convert electrical signals to EM waves and vice versa. Thus, to communicate with other devices over the wireless communication network 10, the improved identification appliance 100 may employ an attached or embedded antenna 134. A microstrip or patch antenna may be used on the improved identification appliance 100, if desired. Patch antennas and identification wristbands using such patch antennas are described in a co-pending patent application filed concurrently, titled “Microstrip Antenna for Identification Appliance”, patent application Ser. No. ______, the entirety of which application is hereby incorporated by reference for all purposes.

Any of the identification appliances or bands described in this disclosure may have electromagnetic energy absorption means so that the identification band may be energized by an external electromagnetic field signal. For example, an antenna may obtain power from a received signal, where the power is used to power some or all of the circuits on the identification appliance. The interrogating/powering electromagnetic signal provides power and enabling information to the identification band. The interrogating/powering signals may contain a power signal only or both a power signal and information modulated onto the power signal. Upon energizing by an electromagnetic signal, the identification band may display optically readable information according to the data programmed in the band, stored in the band, or received from the interrogating/enabling device.

By using the wireless communication network 10, data may be remotely entered into and/or retrieved from the data storage device carried on the improved identification appliance 100. The data may be entered and retrieved by means of an electrical connection to the circuitry to the data storage device carried by the improved identification appliance 100, or remotely via a wireless communication function of the improved identification appliance 100. The data may also be communicated via an electro-optical data link or an acoustical data link.

For example, the improved identification appliance 100 may be equipped to provide information about its location. The location information may be provided over a small area (a room or a building) or a large area (countrywide or worldwide), and may be provided with a varying degree of accuracy (less than 1 meter uncertainty to greater than 1 kilometer uncertainty). The location function may be accomplished by calculation derived by the improved identification appliance 100 of signals received by it (such as Global Positioning System or Local Positioning System signals), or the location function may be derived externally to the identification appliance 100 such as by a matrix of radio frequency receivers responding to the signal strength of communications received from the improved identification appliance 100. As a result, in the example of a patient identification appliance, a hospital may monitor the location and condition of a patient, thereby improving the quality of care for patients in hospitals or in an outpatient setting. In the example of a prison, such an improved identification appliance may provide information about the location of each immate as well as whether each immate has permission to enter certain areas of the prison.

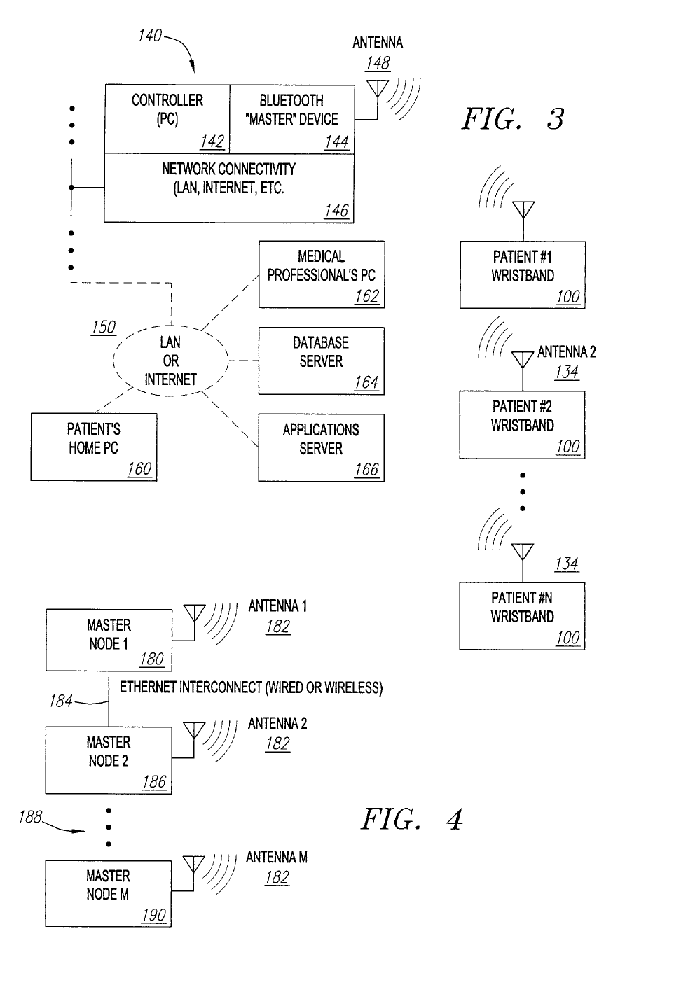

Either a single node or multiple node approach may be used to monitor and otherwise handle a plurality of identification appliances 100. FIG. 3 is a high level representation of an example embodiment of a single node network that is adapted to interact with one or more identification appliances. A master node 140 in this example embodiment comprises a controller 142, a wireless communication circuit 144 and an interface circuit 146. Like the wireless communication circuit 122 of the identification appliance 100, the wireless communication circuit 144 of the master node 140 may enable the master node 140 to communicate with any type or types of devices, systems, or networks over any kind of wireless communication protocol, such as Bluetooth. The controller circuit 142 controls the wireless communication circuit 144 as well as other functions of the master node 140. The controller 142 may comprise, for example, a microprocessor, microcontroller, ALU, CPU, programmable gate array, control circuit, discrete analog or digital hardware and software. The wireless communication circuit 144 may receive, transmit and/or receive and transmit signals via an antenna 148. The interface circuit 146 in this example embodiment allows the master node 140 to connect to other networks such as a local area network (LAN), a wide area network (WAN), a storage area network (SAN), World Wide Web or Internet, or other public or private networks 150. The additional network 150 may be coupled to other devices such as a user's computer, a patient's personal computer 160, a medical professional's computer 162, a database server 164 and various application servers 166. The master node 140 may communicate via antenna 148 to any number N of identification appliances 100. For example, if the master node 140 is in a hospital or medical facility, the improved identification appliance 100 may be wristbands attached to patients' wrists. In this example, each patient's wristband 100 would communicate to the master node 140 through an antenna 134 embedded or otherwise coupled to the communication circuit 122 of the wristband 100. Various functions based on wireless communications may be implemented as described, for example, in this disclosure.

A plurality of identification appliances 100 may also be handled by a multiple node approach. FIG. 4 is a high level representation of a system with multiple master nodes, such as a scatternet, adapted to communicate with one or more identification appliances 100. A first master node 180, which may be the same or different from the master node 140 of FIG. 3, has an antenna 182 and is connected to a second master node 186 via a wired or wireless interconnect 184. This interconnect 184 is preferably an Ethernet connection. The second master node 186 has another antenna 182 to receive, transmit, or transmit and receive data. The second master node 186 is preferably connected to another master node, up to M master nodes 190. This system having multiple master nodes 180, 186, 190 may be useful where each master node intentionally has a limited range for wireless communication with and localization of the improved identification appliance 100. Also, this system having multiple master nodes may be useful when a user of the improved identification appliance 100 is expected to move outside the expected communication range of a single master node.

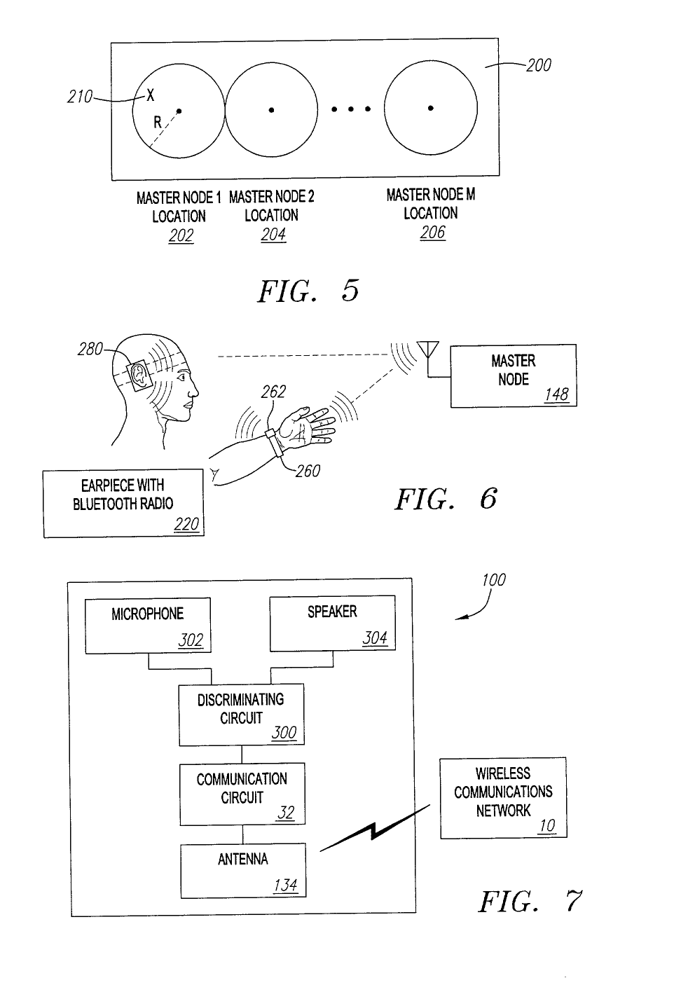

Referring to FIG. 5, an example of using a system of multiple master nodes for zone location is shown. This particular example puts a system having multiple master nodes in a hospital area 200. M number of master nodes 180, 186, 190 are distributed in the hospital area 200, preferably in a manner so that the effective range of each master node either overlaps or is contiguous with that of another master node. Thus, FIG. 5 illustrates an example of a hospital area 200 having M master node locations 202, 204, 206. The circles around each master node represent the effective range of wireless communication with the master node. Although the effective range of a master node is illustrated by circles, other shapes may be appropriate in representing the actual range of each master node. For example, obstacles and interfering objects may affect the actual ability of a master node to communicate with an improved identification appliance 100 at a given location. Nonetheless, master nodes may be positioned to account for these differences. Moreover, a master node may have an antenna or antennae that create an effective range which is elliptical, oval, semicircular, lobed, or petaled. Referring to FIG. 5, if a patient's location 210 is within the range of a first master node 202, the first master node 202 can detect the presence of the patient because of the patient's identification appliance 100. If the patient moves out of range of the first master node and into the range of a second master node 204, the second master node 204 handles the communications with the improved identification appliance 100 of the patient. Hence, a system having multiple master nodes is capable of tracking and maintaining communications with an improved identification appliance 100.

Numerous features and functions may be added to the improved identification appliance 100. For example, the improved identification appliance 100 can notify a local wireless communication network 10 about the status of any other device within the vicinity of the improved identification appliance 100. For instance, the patient's 20 improved identification appliance 100 may be configured to know the status of a medical device (e.g., such as when an intravenous bag is empty) and to transmit the status to a local wireless communication network 10. As another example, the patient's improved identification appliance 100 may be configured to know whether the television is on or off and when the patient turns on the television, the improved identification appliance 100 notifies a local wireless communication network 10 that the television was turned on.

The voice circuit 130 is optional and may enable one or more voice functions. For example, the voice circuit 130 may permit the improved identification appliance 100 to receive, parse, and otherwise process voice commands or voice input. Such a voice circuit 130 may include voice activation and/or speech recognition algorithms. A voice activation function permits the identification appliance 100 to wake up when the appliance 100 detects a voice or a voice activation command. The speech recognition function may utilize any of the well-known speech recognition algorithms to enable the identification appliance 100 to, for example, recognize a particular user's voice and to recognize spoken commands. Such speech recognition algorithms include those which learn and adapt to a user's voice as well as those which are static or pre-trained. Thus, an improved identification appliance 100 which has a voice circuit 130 may wake up when it detects a voice activation command (e.g., “hello” or “wake up”) and obey known voice commands. By having a voice activation function, power is conserved and battery life extended.

The improved identification appliance 100, of course, may have a human perceptible indicator such as a display, light, audible signal generator, vibrator and the like, as described in a co-pending patent application, titled “Enhanced Identification Appliance”, U.S. patent application Ser. No. ______, the entirety of which application is hereby incorporated by reference for all purposes. As an example of sending data to the improved identification appliance 100, a local wireless communication network 10 located in an amusement park may cause all improved identification appliances to display “PARK IS CLOSING”. Alternatively, a subset of improved identification appliances may be told to display a message different than that of another subset of improved identification appliances. For example, in a physical therapy setting, a first round of patients may be informed by their improved identification appliances that their session is over while a second round of patients may be informed by their improved identification appliances that their session is beginning.

Optionally, the wireless communication network 10 may send a command to the improved identification appliance 100. For example, the network 10 may transmit a command to a specification identification appliance 100, all identification appliances 100 that are within range of the local wireless communication network 10, or to a subset of them. The command may be any kind of command. The command can change any operating characteristic or function of the improved identification appliance 100, or cause the improved identification appliance 100 to execute any set of instructions. For instance, the command can change any human perceptible-indicator in the improved identification appliance 100 such as the display, light, audible signal generator, vibrator and the like. As another example, the command may change the frequency at which information is received and/or transmitted between the identification appliance 100 and an external communication system or network. By changing the frequency of transmission or reception, the identification appliance 100 can reduce interference with other identification appliances in the area when the identification appliance 100 is communicating wirelessly with an external device. As yet another example, the command may change the ability of the identification appliance 100 to receive and/or transmit data, the validity of data in the identification appliance 100, a password to communicate with the identification appliance 100, the level or type of encryption of data, the expiration of the identification appliance 100 (e.g., the identification appliance is deemed invalid after it expires), a characteristic in the communications protocol (e.g., baud rate, error correction format, communication header format) so that the identification appliance 100 can be able to communicate with different types of communication networks, and virtually any other operating characteristic or function. The command may also optionally give privileges to the improved identification appliance 100 that the wearer of the identification appliance did not have previously. For example, a wireless communication network may permit the wearer of an improved identification appliance 100 to enter a restricted area, where the permission is time-sensitive and time-limited (e.g., the permission begins at a certain time and expires at a certain time).

Because a wearer of an improved identification appliance 100 may pass through several local wireless communication systems 10, each of which being established in a different or overlapping location, the improved identification appliance 100 should be permitted to enter and exit various local wireless communication systems seamlessly.

Vital patient data may be collected electronically by sensory devices connected to the patient's improved identification appliance 100. Various types of biometric sensors and biometric wristbands are described in another U.S. patent application filed concurrently, titled “Enhanced Identification Appliance”, U.S. patent application Ser. No. ______. For example, such biometric data may include any images of or data about the wearer's fingerprints, retina, iris, or face, or a time domain or frequency domain response of the wearer's voice, or a biochemical assay of the wearer's scent, blood, or breath. In other words, the biometric data may be related to a person's signature, signature plus handwriting dynamics, iris, retina, face recognition, voiceprint, voiceprint and voice stress, fingerprint, other skin pattern, chemical signature (e.g., smell, blood, sweat), DNA signature, or some electric, magnetic, acoustic, or other biometric characteristic. Alternatively, the biometric sensor may provide data about the wearer for purposes other than for identification. For instance, the biometric sensor may be incorporated into the identification appliance to monitor or detect the wearer's pulse rate, heart electrical signals, blood pressure, insulin levels and the like, where such biometric data may be transmitted to other devices (such as monitoring computers at a hospital) constantly, intermittantly, or upon alert conditions. The patient data may be telemetered to one or more readers within the proximity of 100 meters. The wireless communication network 10 may be connected to the Internet, a local area network (LAN), or a personal computer (PC) by customary means known to those of skill in the art. Another option is to set alarm thresholds (e.g., for the patient's body temperature), which when such bounds are exceeded, the patient's improved identification appliance 100 alerts a person or device via pager, telephone, or the Internet in an email. The improved identification appliance 100 may call 911 or another emergency phone number.

The improved identification appliance 100 further provides the patient's data to family members and medical professionals who are off-site, but who have an interest in the status of the patient's condition, whether by monitoring or through notification of a crisis. Thus, in the health care environment, a patient may be provided with an improved RFID appliance 100, which enable health-care professionals and family members to monitor a patient's health status and to remain in contact with the patient via data, alarms, or voice systems.

In one embodiment, a password or other form of access code is required to access private information passing through the wireless communication network 10. In another embodiment, encryption of the sensitive data is used. In yet another embodiment, the improved identification appliance 100 may be power-cycled such that the power to the improved identification appliance 100 is turned off and on periodically, or turned off until a trigger event from the sensor electronics turns the improved identification appliance 100 on, or turned on when the improved identification appliance 100 is tampered with.

For example, the improved identification appliance 100 optionally may have conductive adhesive attachment of areas of the identification appliance, which upon fastening to the patient activates printed conductive patterns within the identification appliance 100 that interface to circuitry in the identification appliance processor section to provide tamper protection. Various types of secure wristbands are described in another U.S. patent application filed concurrently, titled “Enhanced Identification Appliance”, U.S. patent application Ser. No. ______. The configuration and mode of electrical coupling of conductive patterns in the improved identification appliance 100 to the processing or transmitting circuitry may vary according to whether the entire identification appliance is disposable, whether a portion of the identification appliance is a disposable while another portion is not (e.g, a reusable transponder), or whether the entire identification appliance is reusable.

In another alternative embodiment, the improved identification appliance 100 has a power setting or range for wireless communications that is determined at the time of manufacture or activation. That range implicitly serves as a means to locate the identification appliance 100, accurate to within the range of the wireless communication network 10 which is establishing communication with the improved identification appliance 100.

Another alternative embodiment is an improved identification appliance 100 which permits a two-way voice communication between the wearer (e.g., a patient) and another person (e.g., family or medical professionals) so the wearer can make and take calls without moving to find the telephone. Instead the wearer simply puts his improved identification appliance 100 to the vicinity of his mouth. The improved identification appliance 100 has circuitry 130 to detect a voice signal by using standard speech recognition techniques well known in the art. Accordingly, the improved identification appliance 100 may have audio transducers for audio input or output, circuitry or firmware for processing speech sound and providing two-way speech communication with remote units, and circuitry or firmware for deriving biometric data from speech sound.

In another alternative embodiment, the improved identification appliance 100 allows the user to issue voice commands into the identification appliance for performing tasks such as dialing phone numbers, controlling room lights, controlling the TV, setting the bed position, or calling the nurse.

As described earlier, the improved identification appliance 100 maybe configured into any of a variety of shapes and forms. For example, FIG. 6 is a high level representation of an example embodiment of an improved identification appliance with a microphone and headset. The improved identification appliance 100 may include an identification appliance that is configured as a wristband 260, which includes a microphone to receive voice commands and data from the user and an improved identification appliance that is configured as a headband 280, which includes an earpiece 220 to provide audible information to the user. Thus, the improved identification appliance illustrated in FIG. 6 has its receive-and-transmit functions split into two separate devices 260, 280. The wristband 260 can be configured as a neck band instead, which puts the microphone 262 at close proximity to the user's mouth or vocal chords. Such a neckband would be useful for users who are patients with handicaps, disabilities, or frailties. Alternatively, a headphone with a boom microphone may be connected by wire or wireless means to communicate with the improved identification appliance 100. In yet another embodiment, the headphone and microphone, whether wireless or wired, is contained in a headband, where the earphone lies in proximity to one or both ears. In the example embodiment illustrated in FIG. 6, the wristband 260 and headband 280 are able to communicate to one or more master nodes 140. Microphone and earphone transducers may alternatively be bone or skin conduction devices.

FIG. 7 is a high level block diagram representation of an example identification appliance which permits full duplex communications. An identification appliance 100 comprises a communication circuit 32 coupled to a discriminating circuit 300 such as those found in standard speaker phones. The discriminating circuit 300 is coupled to a microphone 302 and a speaker 304 and permits a full-duplex communication (e.g., talk and listen) without needing to manually switch between talking and listening. The communication circuit 32 is coupled to an antenna 134 which transmits information to a wireless communication network 10.

The improved identification appliance 100 may have other optional features. For example, if secured communications is required, communications may be encrypted. Alternatively, the unique biometric qualities of the user's voice may be transmitted, received, or processed in the improved identification appliance 100 with a known modulation scheme.

The improved identification appliance 100 may have acoustical components for sensory, communication and display functions. The improved identification appliance 100 may contain a battery to provide primary or auxiliary power for electronic circuitry carried by it. Optionally, the battery may include a solar component so that the battery is charged or recharged by ambient light; the solar cells and recharging circuitry can be formed out of inorganic or organic materials. The battery may be replaceable or not. The battery may include polymeric substances or be an organic battery imprinted on or constructed on the identification appliance substrate. U.S. Pat. No. 5,973,598 describes a polymer battery which may be used in the improved identification appliance 100. The improved identification appliance 100 may have electronic components made either partially or totally from semiconductors, conductors and insulators, which may be inorganic or organic, and which may be printed on the substrate of the identification appliance. Preferably, the organic components may be those portions of the identification appliance that do not have to operate at high frequencies. U.S. Pat. No. 5,973,598 describes organic components, any of which may be used in the improved identification appliance 100. The substrate and the printed components may be flexible. The entire disclosure of U.S. Pat. No. 5,973,598 is incorporated herein by reference for all purposes.

The improved identification appliance 100 may contain a flexible keyboard (symbolic or alpha-numeric) for data or password entry directly into the electronics of the improved identification appliance 100. The improved identification appliance 100 may be made water resistant, waterproof and resistant to certain solvents or chemicals used in the area of its application.

Also, the identification appliance 100 may be attached to an article where a circuit in the identification appliance 100 performs an optional electronic article surveillance (EAS) function, for example, to indicate the theft of the article. The EAS function does not transmit an identification code, but enables a reader to detect if the identification appliance 100 is near the reader.

The identification appliance 100 may be disposable (in one embodiment) or reusable (in another embodiment) or have a disposable part and a re-usable part (in a third embodiment). It is possible to make the identification appliance 100 disposable and very inexpensive, such as a wristband. The disposable identification appliance 100 may incorporate any of the functions described in this disclosure, where the fastening means is not re-usable and the functionality of the identification appliance 100 is destroyed after its use. However, if desired, some device functions (e.g., data in a nonvolatile memory) may be preserved after use and destruction of the identification appliance. The identification appliance 100 may have a disposable section (for example, structure 120) and a re-usable section (for example, the communication circuit 122). The identification appliance 100 also may be made water resistant, waterproof, and/or resistant to certain solvents or chemicals used in the area of its application.

One application in which the improved identification appliance 100 may be used is airline passenger transportation. The improved identification appliance 100 may incorporate fingerprint or hand-oriented biometric data about the authorized bearer, which information is stored in the data storage device. Such information may be provided visually on the identification appliance 100, if desired. An airline, prior to permitting a passenger to board an airplane, may use a corresponding reader kiosk to read the identification appliance 100 electronically or optically and check the user's fingerprint when his finger is pressed on a fingerprint scanner. Optionally, the user had his fingerprint scanned earlier (e.g., during ticketing or issuance of the identification appliance) and information about that scanned fingerprint is stored in the data storage device on the identification appliance 100. Then when the user has his fingerprint scanned at the gate terminal of the airline prior to boarding the airplane, the user has his fingerprint scanned again, which scan is digitally processed and compared to the information stored in the data storage device on the identification appliance 100 regarding the earlier scanned fingerprint. Any discrepancies between the two fingerprint scans would alert the airline security personnel. The reading device may be constructed so that the fingerprint scanner and the identification appliance reader are in close proximity and isolated from electromagnetically interfering sources, as well as unauthorized surveillance. For example, a hand tunnel can be used where the tunnel both reads the identification appliance and scans the fingerprint (or handprint) at the same time. This would ensure simultaneous reading of the fingerprint and its digitized signature to deter fraud or identification appliance transference.

The system preferably must work through the entire logistical process of ticket reservation, airport arrival, baggage check-in at curbside or at a check-in counter, initial security check, boarding security check, de-planing, transfers within secured areas, transfers out of and re-entry into secured areas, re-boarding, final de-planing, luggage pick-up exit from airport. At this point the identification appliance is removed and its function is disabled.

The identification appliance 100 preferably will contain information about the passenger, photo of the passenger, fingerprint data, both printed and digitized, and information about transactions performed (check in, security check, etc). Visual information is printed on the ticket and electronically stored in the data storage device on the identification appliance 100.

In the foregoing specification, the invention has been described with reference to specific embodiments thereof. It will, however, be evident that various modifications and changes may be made thereto without departing from the broader spirit and scope of the invention. For example, the reader is to understand that the specific ordering and combination of steps described herein is merely illustrative, and the invention can be performed using different or additional steps, or a different combination or ordering of steps. As another example, the improved identification appliance may be used in a Bluetooth scatternet or a Bluetooth piconet. In yet another example, each feature of one embodiment can be mixed and matched with other features shown in other embodiments. Still further, the improved identification appliance in either a single node or multiple node system may use any of the features described in this disclosure. Features and processes known to those of ordinary skill in the art of networking may similarly be incorporated as desired. Additionally and obviously, features may be added or subtracted as desired. Accordingly, the invention is not to be restricted except in light of the attached claims and their equivalents.

What is claimed is:

1. An identification appliance that can communicate with a wireless communication system, the identification appliance comprising:
a structure adapted to be worn by or attached to a person;
a data storage device to store identification data about the person; and
a thin control circuit to communicate with the wireless communication system and being adapted to transmit identification data to the wireless communication system when the identification appliance is within range of the wireless communication system, a portion of the thin control circuit being fabricated at least partially out of an organic material.

2. The identification appliance of claim 1 wherein the control circuit is adapted to receive a command from the wireless communication system.

3. The identification appliance of claim 2 further comprising an audio or visual display.

4. The identification appliance of claim 3 wherein in response to the command, the control circuit changes the audio or visual display.

5. The identification appliance of claim 2 wherein in response to the command, the control circuit transmits the identification data to the wireless communication system.

6. The identification appliance of claim 1 further comprising a position calculation system to determine the location of the identification appliance.

7. The identification appliance of claim 6 wherein the control circuit is adapted to receive a command from the wireless communication system and in response to the command, the control circuit is adapted to transmit the location of the identification appliance to the wireless communication system.

8. The identification appliance of claim 2 wherein in response to the command, a privilege is added to the data storage device for the authorized bearer of the identification appliance.

9. The identification appliance of claim 8 wherein the privilege allows the authorized bearer of the identification appliance to enter a restricted area.

10. The identification appliance of claim 1 wherein the control circuit is formed substantially of at least one organic material.

11. The identification appliance of claim 10 wherein the control circuit is formed entirely of at least one organic material.

12. The identification appliance of claim 1 wherein the identification application lacks an active transmitter so that the wireless communication system reads the data from the data storage device.

13. The identification appliance of claim 1 wherein the identification data includes a passport number.

14. The identification appliance of claim 1 wherein the identification data includes biometric data about the authorized bearer.

15. The identification appliance of claim 14 wherein the biometric data includes fingerprint, voice, or retinal characteristics.

16. The identification appliance of claim 1 wherein the identification appliance is a wristband, armband, ankleband, neckband, legband, or headband.

17. The identification appliance of claim 1 wherein the identification appliance is an identification card.

18. The identification appliance of claim 1 wherein the identification appliance is a patch that can be affixed to an article of clothing.

19. The identification appliance of claim 1 wherein the wireless communication system is a Bluetooth local network, an IRDA, or a wireless local area network.

20. The identification appliance of claim 1 further comprising a power source formed at least partially out of an organic material.

21. The identification appliance of claim 1 further comprising a diode formed of an organic material.

22. The identification appliance of claim 1 wherein the data storage device includes a memory having at least a portion of which is formed of an organic material.

23. A method of identifying a person comprising:
providing an elongate structure adapted to be worn by a person, the structure containing a data storage device to store identification data about the person and a circuit adapted to communicate with an external wireless communication system and adapted to transmit the identification data to the wireless communication system when within range of the wireless communication system, a portion of the circuit being fabricated at least partially out of an organic material;
receiving a signal from the external wireless communication system;
processing the signal; and
transmitting the identification data through the circuit to the external wireless communication system.

24. The method of claim 23 further comprising receiving a command from the external wireless communication system.

25. The method of claim 24 further comprising indicating a status audibly or visually.

26. The method of claim 24 wherein in response to the command, the identification data is transmitted to the external wireless communication system.

27. The method of claim 23 further comprising determining the location of the circuit and in response to receiving a command from the external wireless communication system, transmitting the location of the circuit to the wireless communication system.

28. The method of claim 24 wherein in response to the command, adding a privilege to the data storage device for the person.

29. The method of claim 28 wherein the privilege allows the person to enter a restricted area.

30. The method of claim 23 wherein the circuit is formed predominantly of at least one organic material.

31. The method of claim 30 wherein the circuit is formed entirely of at least one organic material.

32. The method of claim 23 wherein the transmitting of the identification data is passive such that the external wireless communication system reads the identification data from the data storage device.

33. The method of claim 23 wherein the transmitting of identification data includes transmitting a passport number.

34. The method of claim 23 wherein the transmitting of identification data includes transmitting biometric data about the person.

35. The method of claim 34 wherein the biometric data includes fingerprint, voice, or retinal characteristics.

36. The method of claim 23 wherein the elongate structure forms a wristband, armband, ankleband, neckband, legband, or headband.

37. The method of claim 23 wherein the wireless communication system is a Bluetooth local network, an IRDA, or a wireless local area network.

38. The method of claim 23 wherein the circuit is powered by a power source formed at least partially out of an organic material.

39. The method of claim 23 wherein the circuit includes a diode formed of an organic material.

40. The method of claim 23 wherein the data storage device includes a memory formed of an organic material.

41. The identification appliance of claim 1 wherein the control circuit is adapted to receive a command from the wireless communication system, the command being adapted to change an operating characteristic of the identification appliance.

42. The identification appliance of claim 41 wherein the command changes a characteristic in a communications protocol that the control circuit uses to communicate with the wireless communication system.

43. The identification appliance of claim 42 wherein the command changes the frequency at which the control circuit communicates with the wireless communication system.

44. The identification appliance of claim 42 wherein the command changes the speed at which the control circuit communicates with the wireless communication system.

45. The identification appliance of claim 41 wherein the command changes the ability of the control circuit to communicate with the wireless communication system.

46. The identification appliance of claim 41 wherein the command changes the expiration feature of the identification appliance.

47. The method of claim 23 wherein the processing step includes receiving a command from the external wireless communication system, the command being adapted to change an operating characteristic of the circuit.

48. The method of claim 47 wherein the command changes a characteristic in a communications protocol that the circuit uses to communicate with the external wireless communication system.

49. The method of claim 48 wherein the command changes the frequency at which the circuit communicates with the external wireless communication system.

50. The identification appliance of claim 48 wherein the command changes the speed at which the circuit communicates with the external wireless communication system.

51. The identification appliance of claim 47 wherein the command changes the ability of the circuit to communicate with the external wireless communication system.

52. The method of claim 23 wherein the transmitting step communicates at least a portion of the identification data for storage in an external database and stores a link in the data storage device to the externally-stored data.
